(19) United States
(12) Patent Application Publication
(10) Pub. No.: US 2022/0026928 A1
(43) Pub. Date: Jan. 27, 2022

(54) LAYERED SOFTWARE ARCHITECTURE FOR AIRCRAFT SYSTEMS FOR SENSING AND AVOIDING EXTERNAL OBJECTS

(71) Applicant: A^3 BY AIRBUS LLC, Sunnyvale, CA (US)

(72) Inventors: Arne STOSCHEK, Palo Alto, CA (US); Cedric COCAUD, Sunnyvale, CA (US); James LAWSON, Sunnyvale, CA (US)

(73) Assignee: A^3 BY AIRBUS LLC, Sunnyvale, CA (US)

(21) Appl. No.: 17/312,894

(22) PCT Filed: Dec. 17, 2018
(86) PCT No.: PCT/US18/66070

§ 371 Date: Jun. 10, 2021

(51) Int. Cl. G05D 1/10; B64C 39/02; G08G 5/00

(52) U.S. Cl. CPC G05D 1/1064; B64C 39/024; G01S 17/933; G08G 5/0069; G08G 5/0021; G08G 5/0078

(57) ABSTRACT

A monitoring system for an aircraft has sensors configured to sense objects around the aircraft and provide data indicative of the sensed objects. A sense and avoid system is designed in a plurality of software layers, each layer functioning in an independent manner. An evasion software layer is made up of fixed, non-modifiable code that meets an applicable regulatory standard. The remainder of the software layers may be made up of modifiable or non-modifiable code configured so as not to adversely impact the functioning of an evasion software layer, even when modified. Each of the software layers of the sense and avoid system may use information from the sensors and information about the aircraft to generate a recommendation which is ultimately used to determine a possible route that the aircraft can follow to avoid colliding with the sensed object. The aircraft may then be controlled, in accordance with the recommendation, to avoid collision with the object.

### BACKGROUND

Aircraft may encounter a wide variety of collision risks during flight, such as debris, other aircraft, equipment, buildings, birds, terrain, and other objects. Collision with any such object may cause significant damage and/or injury to an aircraft and its occupants. Sensors may be used to detect objects that pose a collision risk and to warn a pilot of detected collision risks. In a self-piloted aircraft, sensor data indicative of objects around the aircraft may be used to avoid collision with the detected objects.

To ensure safe and efficient operation of an aircraft, it is desirable for the aircraft to detect objects in the space around the aircraft. However, detecting objects around an aircraft and determining a suitable path for the aircraft to follow in order to avoid colliding with the objects can be challenging. Systems capable of performing the assessments needed to reliably detect and avoid objects external to the aircraft may be expensive or burdensome to design or implement.

In order for an aircraft to be certified as meeting airworthiness standards, any software and electronic hardware relating to safety-critical operations (such as collision avoidance) must meet certain standards promulgated by the Federal Aviation Administration (FAA), the International Organization for Standardization (ISO), and/or other standards-setting organizations. For example, DO-178 and DO-254, among other standards, may apply to regulate safety-critical hardware and software.

The detection, recognition, and/or avoidance of sensed objects may, in some instances, include one or more intelligent (e.g., autonomous) components capable of independently adapting to new data and previously-performed computations. Such components may not rely on explicitly programmed instructions, instead applying machine learning techniques to progressively generate modified, improved models and algorithms for predictive analyses.

Because model-based software paradigms may not rely on a fixed set of code, several challenges arise with respect to certification standards. Initially, once an aircraft has been certified to meet regulatory standards, the manufacturer of the aircraft may not be able to alter any safety-critical components on which certification was based, including software, without going through a new or supplementary certification process. Such a restriction on modification does not permit a flexible, adaptive solution. Further, even if recertification could be sought after each modification to a piece of software, it may be prohibitively expensive, time-consuming, or otherwise impracticable to have each modification, however minor, repeatedly undergo the certification process.

The ability to develop adaptable, intelligent software for reliably detecting and avoiding objects within a vicinity of an aircraft, while meeting high levels of aviation safety standards and efficiently maintaining any obtained certification for the aircraft, is generally desired.

### BRIEF DESCRIPTION OF THE DRAWINGS

The disclosure can be better understood with reference to the following drawings. The elements of the drawings are not necessarily to scale relative to each other, emphasis instead being placed upon clearly illustrating the principles of the disclosure.

FIG. 1 is a diagram illustrating a top perspective view of an aircraft having an aircraft monitoring system in accordance with some embodiments of the present disclosure.

FIG. 2A is a block diagram illustrating a portion of an aircraft monitoring system in accordance with some embodiments of the present disclosure.

FIG. 2B is a block diagram illustrating a portion of an aircraft monitoring system in accordance with some embodiments of the present disclosure.

FIG. 3 is a diagram illustrating an architecture of a sense and avoid element in accordance with some embodiments of the present disclosure.

FIG. 4 is a block diagram illustrating a sense and avoid element in accordance with some embodiments of the present disclosure.

FIG. 5 is a block diagram illustrating a sense and avoid element in accordance with an alternate embodiment of the present disclosure.

FIG. 6 is a flow chart illustrating a method for sensing and avoiding external objects in accordance with some embodiments of the present disclosure.

### DETAILED DESCRIPTION

The present disclosure generally pertains to architectures for an autonomous solution for aircraft for sensing and avoiding external objects. In some embodiments, an aircraft includes an aircraft monitoring system having sensors that are used to sense the presence of objects around the aircraft for collision avoidance, navigation, or other purposes. At least one of the sensors may be configured to sense objects within the sensor's field of view and provide sensor data indicative of the sensed objects. The aircraft may then be controlled based on an interpretation of the sensor data. The aircraft includes a “sense and avoid” system which is generally directed to the collection and interpretation of the sensor data to determine whether an object is a collision threat, and, if so, to provide a recommendation (also referred to herein as an advisory) of an action to be taken by the aircraft to avoid collision with the sensed object. In a preferred embodiment, the sense and avoid system contains multiple algorithms in a sensing system (to be described in greater detail below), each algorithm taking in data from the same group of sensors, and each algorithm generating an individual output that may be used to generate the advisory.

The outputs of the sensing system may, in some embodiments, include position and vector information representative of an action to be taken by the aircraft. In some embodiments, the outputs may be used by a planning and avoidance system in generating an escape path or action that represents a route that the aircraft can follow to safely avoid a collision with the detected object. As one example of many, the planning and avoidance system may generate an escape action such as “climb at 500 ft/min and maintain regime until an advisory alert is turned off,” though any appropriate type of escape path or action may be used. The escape path or action may, in some embodiments, be passed as an advisory to an aircraft control system that implements the advisory by controlling, as an example, the speed or direction of the aircraft, in order to avoid collision with the sensed object, to navigate the aircraft to a desired location relative to a sensed object, or to control the aircraft for other purposes.

The architecture for the sense and avoid system is designed so as to comprise a plurality of discrete layers, each layer implementing one or more algorithms (or logic) related to the sensing process and/or the collision avoidance process. In a preferred embodiment, a first layer may include a fixed set of non-modifiable code that meets a high level of safety compliance based on any relevant certification and/or regulatory standards. This first layer includes software and/or corresponding computing hardware, all of which may be certificated to the same high safety standard, under any relevant regulations, including those regulations directed to traditional, deterministic software. It will be noted that “traditional” software as used herein refers to its deterministic nature and does not limit such software to any particular programming model. The sensors upon which the first layer relies are also certificatable under that same, high safety standard.

A second layer, independent from the first layer, may, in a preferred embodiment, include a set of code that is modifiable. The first and second layers may be configured to function independently from each other; for example, they may be physically separated on into different computing hardware (e.g., onto different printed circuit boards (PCBs) or onto independent processing units), in whole or in part, and/or logically separated. In addition to this, the second layer is implemented so as to not to adversely affect the safety and performance of the first layer. As a result, even if the code of the second layer were modified, the safety and performance of the first software layer would not be negatively impacted by such modifications. The code of the first layer, remaining unchanged, would continue to meet its relevant certification and/or regulatory standards, and therefore, re-certification (or subsequent certification) of the first layer or of the sense and avoid system as a whole (that is, the totality of software including those of the plurality of layers) would not be necessary.

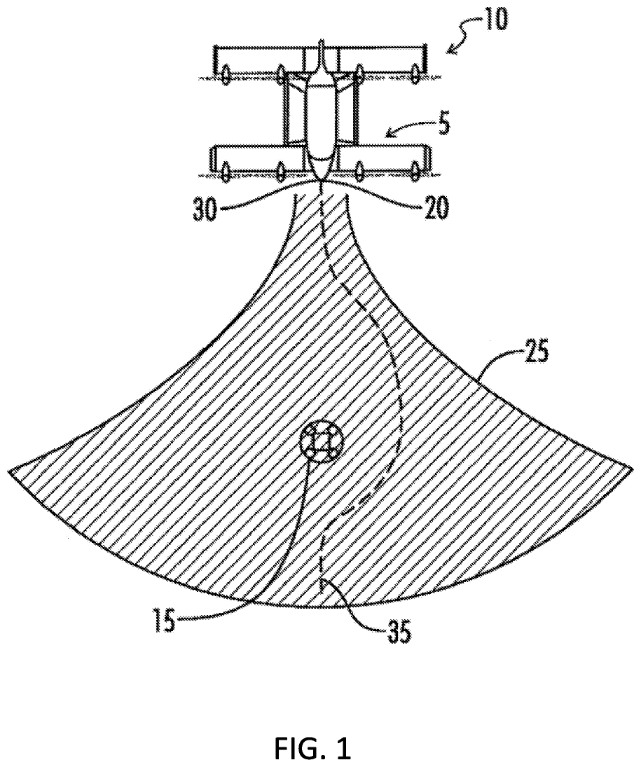

FIG. 1 depicts a top-down perspective view of an aircraft 10 having an aircraft monitoring system 5 in accordance with some embodiments of the present disclosure. FIG. 1 depicts the aircraft 10 as an autonomous vertical takeoff and landing (VTOL) aircraft 10, however, the aircraft 10 may be of various types. The aircraft 10 may be configured for carrying various types of payloads (e.g., passengers, cargo, etc.). In other embodiments, systems having similar functionality may be used with other types of vehicles 10, such as automobiles or watercraft. In the embodiment illustrated in FIG. 1, the aircraft 10 is configured for self-piloted (e.g., autonomous) flight. As an example, aircraft 10 may be configured to perform autonomous flight by following a predetermined route to its destination, under the supervision of a flight controller (not shown in FIG. 1) on the aircraft 10. In other embodiments, the aircraft 10 may be configured to operate under remote control, such as by wireless (e.g., radio) communication with a remote pilot. Alternatively or additionally, the aircraft 10 may be a manned vehicle.

In the embodiment of FIG. 1, the aircraft 10 has one or more sensors 20 of a first type for monitoring space around aircraft 10, and one or more sensors 30 of a second type for providing sensing of the same space or sensing of additional spaces. Any number of sensors, and any number of types of sensors may comprise the illustrated sensors 20, 30. These sensors may, in various embodiments, be any appropriate optical or non-optical sensor(s) for detecting the presence of objects, such as an electro-optical or infrared (EO/IR) sensor (e.g., a camera), a light detection and ranging (LIDAR) sensor, a radio detection and ranging (radar) sensor, transponders, inertial navigation systems and/or global navigation satellite system (INS/GNSS), or any other sensor type that may be appropriate. For example, a sensor may be configured to receive a broadcast signal (e.g., through Automatic Dependent Surveillance-Broadcast (ADS-B) technology) from the object 15 indicating the flight path of the object 15.

For ease of illustration, FIG. 1 only depicts sensors 20, 30 at the front of the aircraft 10, however, in a preferred embodiment, sensors 20, 30 may be located in various positions on the aircraft 10 and may have a full or partial field of view around the aircraft in all directions. The aircraft monitoring system 5 of FIG. 1 is configured to use the sensors 20, 30 to detect an object 15 that is within a certain vicinity of the aircraft 10, such as near a flight path of the aircraft 10. Such sensor data may then be processed to determine whether the object 15 presents a collision threat to the vehicle 10. In this regard, aircraft monitoring system 5 may be configured to determine information about the aircraft 10 and its route. The aircraft monitoring system 5 may, for example, determine a safe escape path for the aircraft 10 to follow that will avoid a collision with the object 15.

The object 15 may be of various types that aircraft 10 may encounter during flight, for example, another aircraft (e.g., a drone, airplane, or helicopter), a bird, debris, or terrain, or any other of various types of objects that may damage the aircraft 10, or impact its flight, if the aircraft 10 and the object 15 were to collide. The object 15 is depicted in FIG. 1 as a single object that has a specific size and shape, but it will be understood that object 15 may represent one or several objects that may take any of a variety of shapes or sizes and may have various characteristics (e.g., stationary or mobile, cooperative or uncooperative). In some instances, the object 15 may be intelligent, reactive, and/or highly maneuverable, such as another manned or unmanned aircraft in motion.

The embodiment of FIG. 1 further generally illustrates how a detected object 15 may be avoided. The aircraft monitoring system 5 may use information about the aircraft 10, such as the current operating conditions of the aircraft (e.g., airspeed, altitude, orientation (e.g., pitch, roll, or yaw), throttle settings, available battery power, known system failures, etc.), capabilities (e.g., maneuverability) of the aircraft under the current operating conditions, weather, restrictions on airspace, etc., to generate one or more paths that the aircraft is capable of flying under its current operating conditions. This may, in some embodiments, take the form of generation of an escape envelope 25 that defines the boundaries of a region representing a possible range of paths that aircraft 10 may safely follow. The escape envelope 25 (shown as a “funnel” shape) may be understood as the envelope or universe of possible avoidance maneuvers. This escape envelope may take any shape but generally widens at points further from the aircraft 10, indicative of the fact that the aircraft 10 is capable of turning farther from its present path as it travels. The aircraft monitoring system 5 may then select an escape path 35 within the escape envelope 25 for the aircraft 10 to follow in order to avoid the detected object 15.

In identifying an escape path 35, the aircraft monitoring system 5 may use information from sensors 20, 30 about the sensed object 15, such as its location, velocity, and/or probable classification (e.g., that the object is a bird, aircraft, debris, building, etc.). Sensors 20, 30 are capable of detecting objects anywhere within their field of view. As mentioned above, the sensors have a full or partial field of view all around the aircraft (not specifically shown) in all directions; the field of view is not limited to the escape envelope 25 illustrated in FIG. 1. Escape path 35 may also be defined such that the aircraft will return to the approximate heading that the aircraft was following before performing evasive maneuvers.

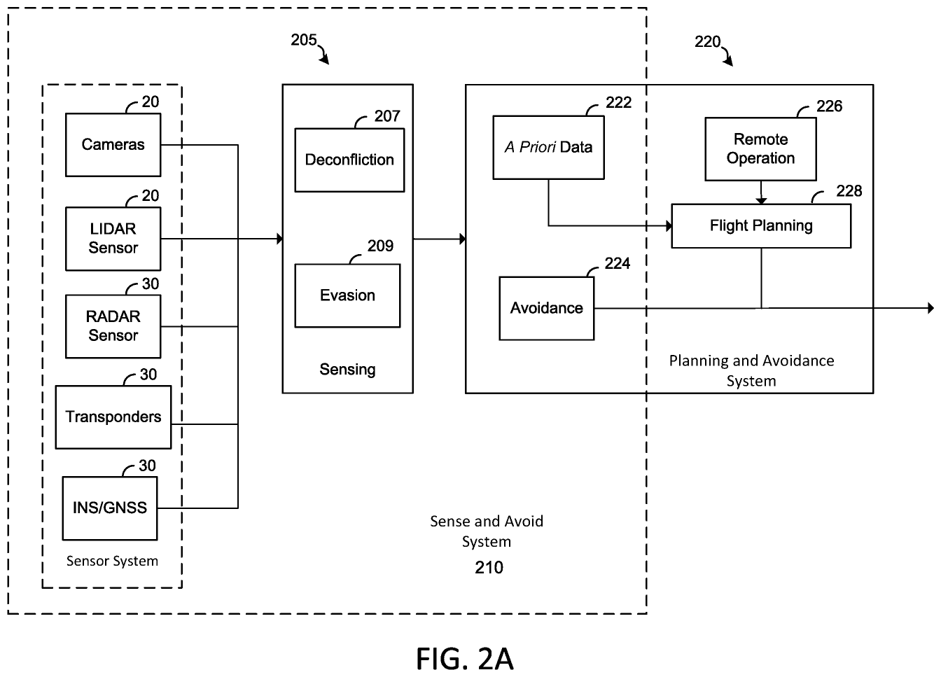

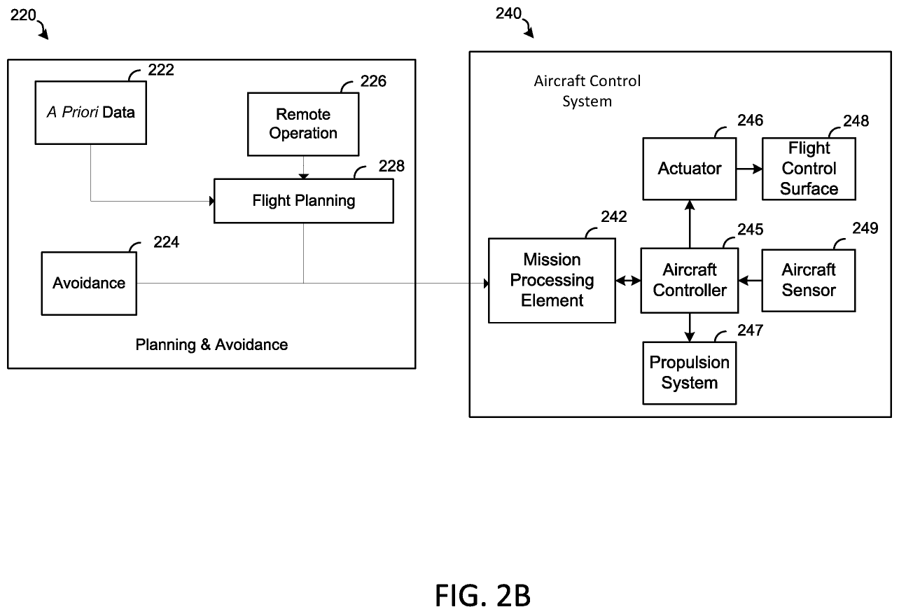

FIGS. 2A and 2B depict an embodiment of the aircraft monitoring system 5 including one or more sensors 20, one or more sensors 30, a sensing system 205 (that may include, e.g., an evasion system 209 and a deconfliction system 207 described in greater detail below) (FIG. 2A), a planning and avoidance system 220 (that may include, e.g., an avoidance system 224 and a flight planning system 228, among other components) (FIGS. 2A and 2B), and an aircraft control system 240 (that may include, e.g., a mission processing element 242, an aircraft controller 245, a propulsion system 247, and one or more actuators 246, among other components) (FIG. 2B). In the embodiment illustrated in FIGS. 2A and 2B, the components of the aircraft monitoring system 5 may reside on the vehicle 10 and may communicate with other components of the aircraft monitoring system 5 through wired (e.g., conductive) and/or wireless (e.g., wireless network or short-range wireless protocol, such as Bluetooth) communication, however alternate implementations may be used in different embodiments.

It will be understood that the components shown in FIGS. 2A and 2B are merely illustrative, and the aircraft monitoring system 5 may comprise various components not depicted for achieving the functionality described herein and for generally performing collision threat-sensing operations and vehicle control. Similarly, although particular functionality may be ascribed to various components of the aircraft monitoring system 5 as discussed herein, it will be understood that in other alternate embodiments, such functionalities may be performed by different components, or by one or more components.

With reference to FIG. 2A, a combination of some components from the sensors 20, 30, the sensing system 205, and the planning and avoidance system 220 function together as a “sense and avoid” element 210. As shown in FIG. 2A, sensing system 205 may in some embodiments be coupled to each of sensors 20 and sensors 30. The sense and avoid element 210 may perform processing of sensor data (as well as other data, such as flight planning data (e.g., terrain and weather information, among other things) and/or data received from aircraft control system 240 regarding an escape envelope) to generate a recommendation (also referred to as an advisory) for an action to be taken by the aircraft controller 245.

Data in support of this recommendation may be sent from the sensing system 205 to an avoidance element 224 (of planning and avoidance system 220), which applies an avoidance algorithm thereto to generate an optimized escape path. In some embodiments, the avoidance element may be an ACAS or ACAS-X system. In some embodiments, the avoidance algorithm may be deterministic in nature. This algorithm may, in some embodiments, also consider information from flight planning system 228. Such information may include, for example, a priori information, e.g., terrain information about the placement of buildings or other known static features, information about weather, airspace information, including known flight paths of other aircrafts (for example, other aircrafts in a fleet), and/or other relevant predetermined (or pre-discoverable) information.

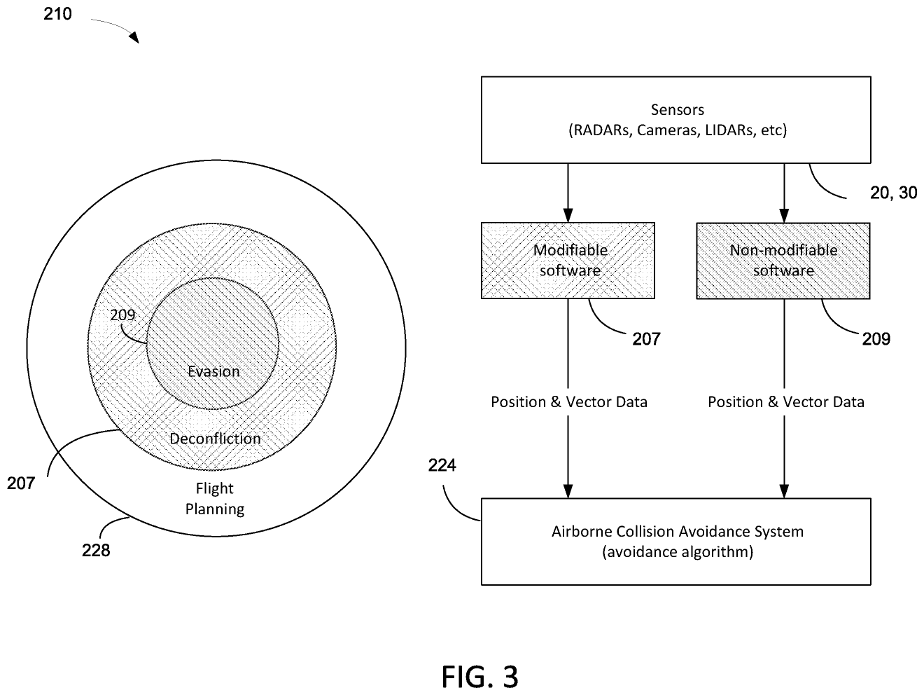

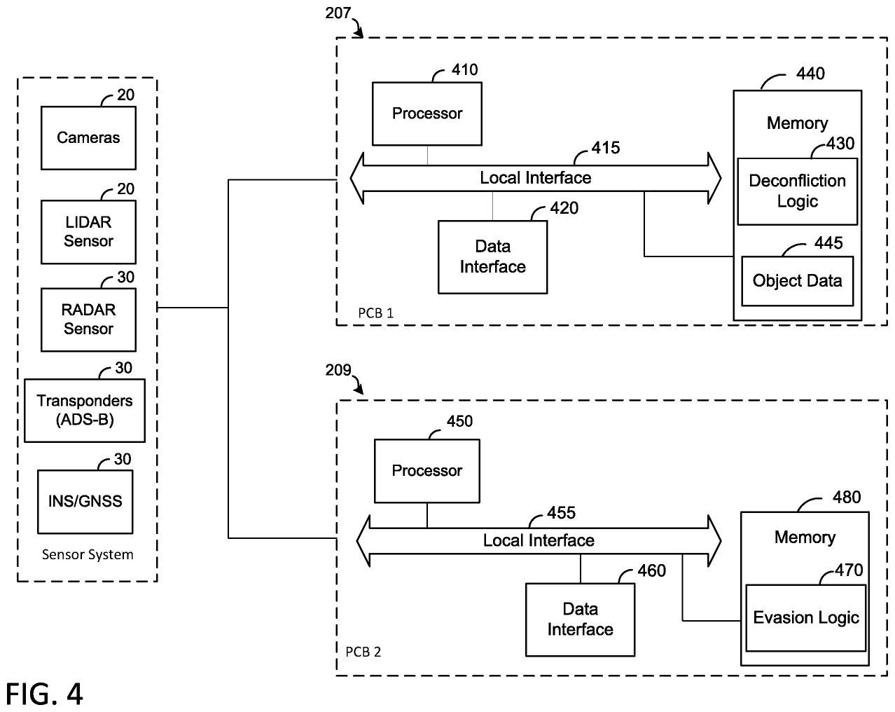

The sense and avoid element 210 and the other elements of planning and avoidance system 220 may be implemented in hardware or a combination of hardware and software/firmware. As an example, the sense and avoid element 207 may comprise one or more application-specific integrated circuits (ASICs), field-programmable gate arrays (FPGAs), and/or microprocessors programmed with software or firmware, or other types of circuits for performing the described functionalities. Exemplary configurations of components of the sense and avoid element 210 will be described in more detail below with reference to FIGS. 3 and 4.

With reference to FIG. 2B, the planning and avoidance system 220 may provide the generated path and/or other signals to the mission processing element 242 of aircraft control system 240. In some embodiments, the aircraft controller 20 may perform suitable control operations of the aircraft 10 by providing signals or otherwise controlling a plurality of actuators 246 that may be respectively coupled to one or more flight control surfaces 248, such as rudders, ailerons, elevators, flaps, spoilers, brakes, or other types of aerodynamic devices typically used to control an aircraft. Although a single actuator 246 and a single flight control surface 248 are depicted in FIG. 2B for simplicity of illustration, any practical number of actuators 246 and flight control surfaces 248 may be implemented to achieve flight operations of aircraft 10. The propulsion system 247 may comprise various components, such as engines and propellers, for providing propulsion or thrust to the aircraft 10. One or more aircraft sensors 249 may monitor operation and performance of various components of the aircraft 10 and may send feedback indicative of such operation and performance to the aircraft controller 245. In response to the information provided by the aircraft sensor 249 about performance of the systems of the aircraft 10, the aircraft controller 245 may control the aircraft 10 to perform flight operations.

It will be understood that the aircraft controller 245 is a reactive system, taking in the recommendation of the sense and avoid system 210 and reacting thereto. In response to receiving the recommendation, the mission processing element 242 may be configured to provide a signal to aircraft controller 245 to take an action in response to the threat, such as providing a warning to a user (e.g., a pilot or passenger) or controlling the aircraft control system 240 (e.g., actuators 246 and the propulsion system 247) to change the velocity (speed and/or direction) of the aircraft 10. As an example, the aircraft controller 245 may control the velocity of the aircraft 10 in an effort to follow an escape path 35, thereby avoiding a sensed object 15. Alternatively, the aircraft controller 245 may navigate to a desired destination or other location based on the sensed object 15.

In alternate embodiments, the functions of the planning and avoidance system 220 (or just avoidance logic 224) and those of the mission processing element 242 may be implemented with the same computing hardware or may share processors or other resources. That is, the avoidance logic 224 may be implemented on a computer system of the mission processing element 242, or, alternatively, the mission processing element 242 may be implemented on a computer system of the planning and avoidance system 220, that is, some subset of the computing hardware used by the sense and avoid system 210.

It will be understood, with reference to FIGS. 2A and 2B, that any number of computers may be used in the implementation of the aircraft monitoring system 5. Specifically, using different processors or other hardware helps to spread processing burdens across hardware resources. In addition, separating components across different hardware helps to isolate any one element from a hardware failure that may be affecting another element. Furthermore, using different processors or other hardware for the sense and avoid element 210 and/or other components may help to reduce design and manufacturing costs. On the other hand, considerations of weight and power consumption on the aircraft may limit the number of discrete computing units on which the functions may be implemented. The foregoing limitations and opportunities notwithstanding, in a preferred embodiment, sensing system 205 may be implemented on its own computing system (or over multiple computing systems dedicated to the sensing system 205), due to the computational power required for the relatively high amount of processing performed by the system, and the sensing system's particular safety requirements (described below), though other embodiments may be differently implemented, such as on a shared computing system.

FIG. 3 illustrates the general principles of the design of the sensing system 205. The left side of FIG. 3 depicts a layered arrangement of the sensing system 205 of the sense and avoid system 210. In the illustrated embodiment, sensing system 205 is designed so as to comprise a plurality of discrete “layers” of software and/or supporting computer hardware. The innermost depicted layer is the evasion layer 209. Exterior to, and separate from, the evasion layer 209 is a deconfliction layer 207. In some embodiments, the sense and avoid system 210 also includes a flight planning layer 228. Each of these layers contains one or more algorithms for generating a recommendation for an action to be taken by the aircraft in response to the detection of a collision.

The right side of FIG. 3 depicts a block diagram of the logical flow of the sensing system 205. A sensor suite 20, 30 takes in measurements from outside the aircraft 10. In a preferred embodiment, the same sensors 20, 30 feed information into the evasion layer 209 and the deconfliction layer 207, however, in alternate embodiments, different groupings of sensors may be respectively used for each. Position and vector data from the evasion layer 207 and the non-modifiable software 209 may then be provided to an avoidance algorithm 224. In some embodiments, the avoidance algorithm is an Airborne Collision Avoidance System (ACAS), though other algorithms are possible in other embodiments.

As depicted in FIG. 3, the evasion layer 209 and the deconfliction layer 207 process the sensor data using different types of algorithms. A first architectural layer, evasion layer 209, is identified in FIG. 3 as “non-modifiable” software, including only a static set of code that is not changed through the life of the aircraft monitoring system 5. Evasion layer 209 may be designed to meet any relevant certification and/or regulatory standard. The code in the evasion layer 209 is deterministic in nature, such that the data output of the logic of the evasion layer 209 will always be the same, given a certain input.

The second layer, deconfliction layer 207, contains “modifiable software,” for example, adaptive models and algorithms. The deconfliction layer 207 may be, in some embodiments, an intelligent system that relies on a neural network. The deconfliction layer 207 may be probabilistic in nature (using probability models) where the data output of the system may vary, even if given the same input, as the system adapts to localized changes.

The results of the two algorithms (evasion and deconfliction) may be converted or placed into standard formats and are provided to the planning and avoidance system 220, which generates an advisory based thereon. In a preferred embodiment, as described above, the avoidance element 224 may take the form of an ACAS system. In one embodiment, avoidance element 224 may be an ACAS-X implementation.

To explain it in another way, in the preferred embodiment, when an object 15 is detected, each of the evasion layer 209 and the deconfliction layer 207 receives data from the sensors 20, 30 and follows a respective process to provide position and vector information to the planning and avoidance system 220. Deconfliction layer 207 uses a non-deterministic method such as machine learning to classify the object 15 and to predict its position and vector data based on one or more sets of training data, e.g., historical data on detected objects and/or the paths those detected objected followed. The evasion layer 209 uses a deterministic method such as a mathematical rule, or other information, stored in memory (for example, a set of pre-established ‘if-then-else’ rules or other closed-form mathematical expressions), to provide position and vector data. Because these sense and avoid decisions are being made separately and in parallel to each other, the different evasion and deconfliction logics may result in discrepancies between the two sets of results provided to the planning and avoidance system 220. However, in a case where an object moves too close to the aircraft, or otherwise poses a threat to the aircraft that requires immediate action, the evasion layer 209 will override the deconfliction layer 207.

In the embodiment of FIG. 3, a third “flight planning” layer may be included. The flight planning layer 228 considers pre-existing information, meaning information that was known before the flight that is nonetheless relevant to avoid collisions. Such information may include, for example, a priori information including terrain information about the placement of buildings and other static features, information about weather, airspace information, including known flight paths of other aircrafts (e.g., other aircrafts in a fleet), and/or other relevant pre-existing information.

In one embodiment, the layers of the sense and avoid system may be designed to meet various safety classifications used by the FAA, e.g., the Design Assurance Levels (DALs) “A” through “E”, each level being respectively less stringent. The evasion layer 209 is made of software and computing/or hardware that are certificatable to a high safety standard, under any relevant regulations, including those regulations directed to traditional (deterministic, and in some cases, single-thread) software. Such standards may include, among other things, industry standards such as DO-178 and DO-254. As an example, with reference to the FAA's letter-based Design Assurance Level classifications, in a preferred embodiment, the software and computing hardware of the evasion layer might meet at least a DAL-B level certification. The sensors upon which the evasion layer relies would also be certificatable under at least that same safety standard—as a single sensor of the same safety standard or as a combination of multiple sensors of lower standard implemented so as to meet the same safety standard—as per the regulatory body standards. It will also be understood that every subsystem to the evasion layer meets this same safety standard. In other embodiments, the software and hardware of the evasion layer and the sensors may be designed to meet a higher or lower level of certification than DAL-B level.

In a preferred embodiment, the software and/or hardware of the deconfliction layer are also designed so as to meet regulatory standards, such as FAA safety standards. However, because the software of the deconfliction layer is modifiable, limitations may exist on the explicit certification of the deconfliction layer under the FAA's standards, so that certification may or may not be worth seeking, or may or may not be practical.

In some embodiments, the deconfliction layer may be designed to meet a less stringent classification than the evasion layer. In other words, because the evasion layer 209 serves as a backup net of collision avoidance, fewer errors are permitted in the functioning of the evasion layer 209 than in the deconfliction layer 207. However, alternate embodiments are possible where the deconfliction layer is designed to meet the same classification of safety standard as the evasion layer.

In some embodiments, the deconfliction layer 207 may use the same sensors as those used by the evasion layer 209. In such an implementation, the sensors used by the deconfliction layer would be certificatable to at least the same high standard of the evasion layer. However, in an alternate implementation, the deconfliction layer may use a separate set of sensors than those used by the evasion layer. In this alternate implementation, the sensors used by the deconfliction layer need only meet the same safety standards as those met by the software and hardware of the deconfliction layer itself.

In a preferred embodiment, the evasion layer and the deconfliction layer are logically decoupled, so as to function discretely. Each layer is capable of acting without preliminary, concurrent, or subsequent action by the other layer. Put another way, the algorithms of the deconfliction layer have no adverse impact on, and cannot override, the functionality of the evasion layer, that is, they do not alter, impede, or worsen the evasion layer's output result, efficiency, performance, or the like, or take resources from the functioning of the evasion layer. Because the deconfliction layer 207 does not interfere with the functions performed by the evasion layer 209, the functions of the deconfliction layer 207 do not adversely impact the safety compliance of the evasion layer. This independence may be shown, for instance, through the event logs of the software and hardware of the Sense and Avoid system, or by other appropriate types of evidence. Accordingly, it will be understood that modification of the deconfliction layer 207 does not by itself create a need to seek a recertification of the evasion layer 209 under the FAA's (or other agency's) safety standards. Therefore, even if the code of the deconfliction layer is modified (e.g., to meet ever increased standards for probability models, improved neural networks, etc.), the code and safety level provided by the evasion layer remains un-impacted and unchanged by such modifications. The evasion layer, being designed to conform to any relevant certification and/or regulatory standards, remains unchanged. The architecture of the sense and avoid system as a whole (that is, the totality of software including the plurality of layers) would also continue to meet such standards (even potentially improving in performance) even after any change to the code of the second layer. Because the system maintains the integrity of the already-certified evasion layer 209 even after a change to the deconfliction layer 207, re-certification or supplemental certification of the software as a whole would therefore not be necessary.

While FIG. 3 depicts three (3) layers of algorithms, it may be understood that in different embodiments, any number of layers is permissible, provided that at least one layer is comprised of non-modifiable software, while another is modifiable independently of the first layer.

As will be understood in FIGS. 2A, 2B, and 3, the sense and avoid system 210 does not itself take control of the aircraft 10, the actuators 246, or the propulsion systems 247. Rather, the sense and avoid system 210 provides a recommendation of an action that the aircraft control system 240 should take. This recommendation information is sent to mission processing element 242 to compute an optimized path, which is ultimately passed to the aircraft controller 245. The aircraft controller 245 may then control the actuators and propulsion of the aircraft in accordance with the recommendation.

FIG. 4 illustrates a block view of the sensing system 205. The sensing system 205 may be implemented in hardware or a combination of hardware and software/firmware. In one embodiment, the evasion layer 209 and the deconfliction layer 207 may be arranged so as to be on different processing cores from each other. As an example, the evasion layer 209 and the deconfliction layer 209 may each include one or more application-specific integrated circuits (ASICs), field-programmable gate arrays (FPGAs), and/or microprocessors programmed with software or firmware, or other types of circuits for performing the described functionalities.

In one embodiment, the deconfliction layer and the evasion layer are implemented on two different processing units (or computers). In the exemplary embodiment of FIG. 4, for example, this might take the form of implementation on two different printed circuit boards, PCB 1 and 2, respectively. In alternate embodiments, the layers may function on the same board, but on different processing cores. By this setup, a physical (e.g., environmental) upset to one of the PCBs (or, alternatively, processing units) would not impact the functioning of the other. What is more, because the evasion layer 209 and the deconfliction layer 207 work in parallel, even in the instance of a failure, the sensing system 205 would still function satisfactorily. In an alternate embodiment, the evasion and deconfliction logics may be on the same board, however, they may be implemented so as to be logically decoupled.

As shown by FIG. 4, the deconfliction layer 207 and the evasion layer 209 may respectively include one or more processors 410 and 450, one or more of memory 440 and 480, one or more of data interfaces 420 and 460, and at least one local interface 415 and 455. The processors 410, 450 may be configured to execute instructions stored in memory 440, 480 in order to perform various functions, such as processing of sensor data from the sensors 20, 30 (FIGS. 1, 2A, 2B). The processors 410, 450 may include any of a central processing unit (CPU), a digital signal processor (DSP), a graphics processing unit (GPU), an FPGA, or other types of processing hardware, or any combination thereof. Further, the processors 410, 450 may include any number of processing units to provide faster processing speeds and redundancy.

The processors 410, 450 may communicate to and drive the other elements via the local interfaces 415, 455, which may include at least one bus. Further, the data interfaces 420, 460 (e.g., ports or pins) may interface components of the sensor system 205 with other components of the aircraft controller system 5, such as the sensors 20, 30 and any components of the aircraft control system 5.

As shown by FIG. 4, the deconfliction layer 207 may comprise deconfliction logic 430 and the evasion layer 209 may comprise evasion logic 470, which logic may be implemented in hardware, software, firmware, or any combination thereof. In FIG. 4, the deconfliction and evasion logic are implemented in software and stored in respective memories for execution by the processors 410, 460. However, other configurations are possible in other embodiments.

As mentioned earlier, both the evasion layer 209 and deconfliction layer 207 function separately to provide recommendations including position and vector information for the aircraft 10 to navigate around the object 15. In practice, the deconfliction layer 207 can also be designed to intelligently determine a recommendation for an escape that leads to a smoother flight more suited to a passenger experience. That is, while both the evasion and deconfliction layers will provide an advisory that can be used to avoid collision, the advisory provided by the deconfliction layer is backed by a probabilistic analysis that allows for a more developed choice of escape path. In this regard, the deconfliction layer 207 may, in some embodiments, employ a machine learning algorithm to classify and detect the location of an object 15 in order to better assess its possible flight performance, such as speed and maneuverability, and threat risk. In this regard, the deconfliction layer 207 may store object data 445 in memory 440 that is indicative of various types of objects, such as birds or other aircraft, that might be encountered by the aircraft 10 during flight. For each object type, the object data 445 defines a signature that can be compared to sensor data to determine when a sensed object corresponds to the object type. As an example, the object 445 may indicate the expected size and shape for an object that can be compared to an object's actual size and shape to determine whether the object 15 matches the object type. It is possible to identify not just categories of objects (e.g., bird, drone, airplane, helicopter, etc.) but also specific object types within a category.

It will be apparent that in the embodiment of FIG. 4, the evasion and deconfliction layers are arranged on different hardware from each other. Alternatively, the evasion and deconfliction layers may share hardware but be arranged to be logically independent from each other. In some alternative embodiments, the code of the evasion and deconfliction layers may include position-independent code, or may be stored in different sections of a memory.

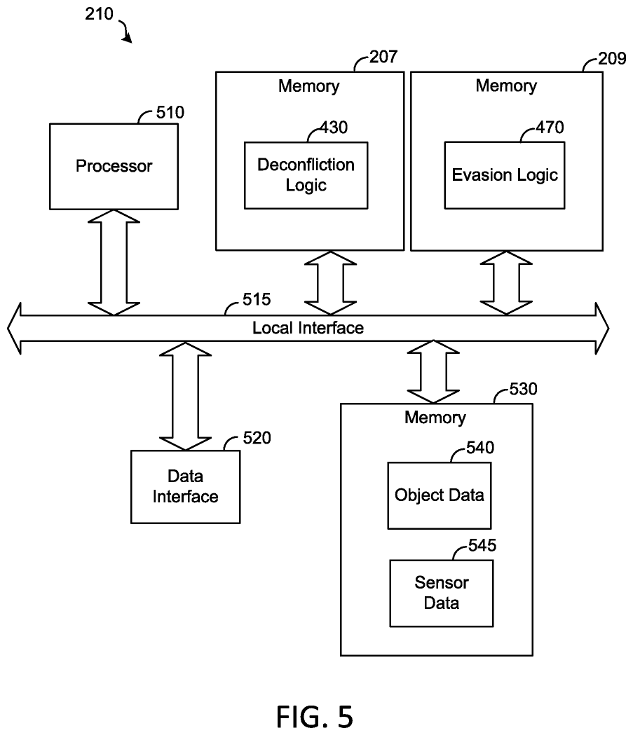

FIG. 5 illustrates an alternate embodiment of a configuration of the sensing system 205. FIG. 5 presents an embodiment where the deconfliction layer 207 and the evasion layer 209 share one or more processing resources 510 and one or more of memory 530 that stores sensor data 545 and object data 540. In one embodiment, the evasion logic 470 will not use object data 540 in its analysis of the acquired sensor data, if the algorithms of evasion logic 470 are not robust enough to perform the detailed classification performed by the deconfliction logic 430. However, in other embodiments, the evasion logic may be more robust, for example, using the object data 540 to, for example, perform some type of pattern matching with past object data or templates. In some embodiments, sensor data used by the evasion layer 209 may differ from sensor data used by the deconfliction layer, so as to be stored separately in memory 530, or in different memories. In other embodiments, there may be redundancy of sensor data between the two layers.

Note that the sense and avoid logic 350 or components thereof, when implemented in software, can be stored and transported on any computer-readable medium for use by or in connection with an instruction execution apparatus that can fetch and execute instructions. In the context of this document, a “computer-readable medium” can be any means that can contain or store code for use by or in connection with the instruction execution apparatus.

Alternate embodiments may include additional architectural layers (e.g., a third, fourth, fifth, or n^{th} layer) made up of modifiable or non-modifiable code. If the architecture includes any additional layers, such layers are also independent from the fixed code of the evasion layer 209, so as not to adversely impact the functionality of that layer.

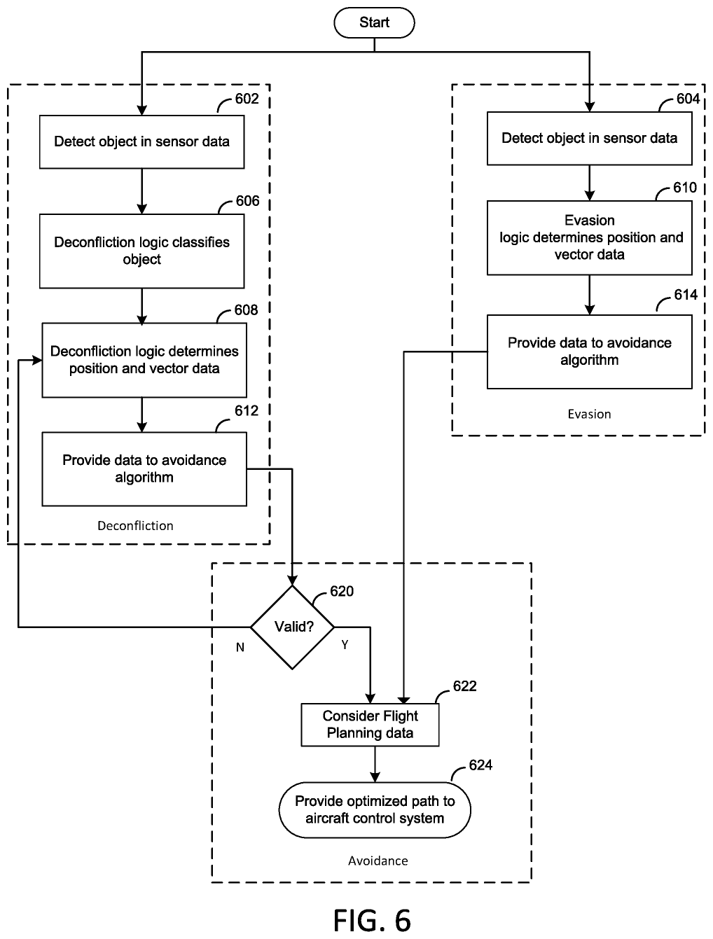

An exemplary use and operation of the aircraft monitoring system 5 in order to sense and avoid objects 15 within a path of the aircraft 10 will be described in more detail below with reference to FIG. 6. For illustrative purposes, it will be assumed in FIG. 6 that an object 15 is within the path of aircraft 10 and in field of view of at least one of sensors 20, 30.

FIG. 6 illustrates an exemplary method for sensing and avoiding external objects. At steps 602 and 604, sensing system 205 may receive data from one or more sensors 20, 30, and may detect an object 15 within the sensor data. The sensing system 205, in a preferred embodiment, acts in parallel to process sensor data in the deconfliction layer 207 (step 602) and in the evasion layer 209 (step 604), though in other embodiments, the sensing system 205 may not handle both sets of data in parallel. In some embodiments, some of sensors 20, 30 send data to the deconfliction layer 207 and others of sensors 20, 30 send data to the evasion layer 209, however, in alternate embodiments, the same sensors are used by both layers. In the embodiment illustrated in FIG. 6, steps 602 and 604 use different algorithms for objection detection. For example, in step 602, the deconfliction layer 207 may use a machine learning detection, while, in step 604, the evasion layer 209 may use a classical deterministic detection, though other detection methods may be used by either module in different embodiments.

Turning first to the process of the deconfliction layer, based on the information about the object 15 sensed by the sensors 20, 30 (location, velocity, mass, size, etc.), the deconfliction layer 207 may, in step 606, classify the object 15, or, in other words, identify an object type for the detected object 15. Thereafter, processing may continue to step 608, where the deconfliction layer 207 may determine position and vector data, and then to step 612, where such data is sent to the avoidance algorithm in planning and avoidance system 220.

In the illustrated process of the evasion layer, no classification of the object is done. Rather, based on the detected sensor data, the evasion layer 209 may determine position and vector data (step 610), and may send such data to the avoidance algorithm 224 in step 614.

The planning and avoidance system 220 receives both sets of data in step 622. In some embodiments, the avoidance algorithm 224, whether by itself or in combination with the mission processing element 242, may validate the position and vector data sent by the deconfliction layer 207 (step 620). The planning and avoidance system 220 then considers flight planning data from flight planning system 228 (step 622), and, in step 624, provides a flight path (recommendation or advisory) to the aircraft control system 254.

As described above, position and vector data is sent from both the deconfliction layer and the evasion layer in a redundant manner. This is done for the purpose of enhancing aircraft safety, that is, the evasion layer may act as a safety net, or backup, to the more processing heavy calculations of the deconfliction layer, the results of which may depend on the quality of the data used. In some instances, the planning and avoidance system 220 may choose to use one received set of position/vector data over another. The reasons for such selection may vary. For example, the planning and avoidance system 220 may notice a large discrepancy between the data provided by the two sensing system algorithms, which might suggest that that one is in error. Additionally, the system 220 may recognize a hardware failure relative to either the deconfliction layer 207 or evasion layer 209, or to a sensor specific to those layers. Where a failure has occurred, the aircraft monitoring system 5 may be configured to take corrective action, such as deactivating the failed processor or ignoring its output for future control decisions. In this manner, one of the sensing algorithms (e.g., the evasion layer, which meets a higher safety standard) may function as a check, or safety net, to the higher performance and changeable functionality of the deconfliction layer. In addition, as described above, in a case where an object moves too close to the aircraft, or otherwise poses a threat to the aircraft or its passengers that requires immediate action, the evasion layer 209 will override the deconfliction layer 207 to instruct the aircraft controller to move the aircraft to a safe position.

The foregoing is merely illustrative of the principles of this disclosure and various modifications may be made by those skilled in the art without departing from the scope of this disclosure. The above described embodiments are presented for purposes of illustration and not of limitation. The present disclosure also can take many forms other than those explicitly described herein. Accordingly, it is emphasized that this disclosure is not limited to the explicitly disclosed methods, systems, and apparatuses, but is intended to include variations to and modifications thereof, which are within the spirit of the following claims.

As a further example, variations of apparatus or process parameters (e.g., dimensions, configurations, components, process step order, etc.) may be made to further optimize the provided structures, devices and methods, as shown and described herein. In any event, the structures and devices, as well as the associated methods, described herein have many applications. Therefore, the disclosed subject matter should not be limited to any single embodiment described herein, but rather should be construed in breadth and scope in accordance with the appended claims.

What is claimed is:

1. A monitoring system for an aircraft, comprising:
a plurality of sensors for sensing an object external to the aircraft;
a system comprising a first logic and a second logic, each of the first logic and the second logic including respective instructions for both (a) receiving data indicative of an object sensed by the plurality of sensors, and (b) generating a recommendation for avoiding the object based on the received data; and
a controller configured to control a direction of the aircraft based on a generated recommendation,
wherein the instructions included in the first logic are non-modifiable and the instructions included in the second logic are modifiable.

2. The monitoring system of claim 1, wherein if the instructions included in the second logic are modified, the instructions included in the first logic are not modified in accordance with the modification to the instructions included in the second logic.

3. The monitoring system of claim 1, wherein the system comprising the first logic and the second logic includes a first set of one or more processors configured to implement the first logic and a second set of one or more processors configured to implement the second logic.

4. The monitoring system of claim 1, wherein the first logic and the second logic are respectively implemented on a first circuit board and a second circuit board.

5. The monitoring system of claim 1, wherein the instructions included in the second logic, when implemented, are configured to classify the object based on the instructions included in the second logic, thereby determining an object type for the object.

6. The monitoring system of claim 1, wherein the instructions included in the second logic, when implemented, are configured to localize the object.

7. The monitoring system of claim 1, wherein the system comprising the first logic and the second logic further comprises a third logic, the third logic containing instructions which, when implemented, are configured to analyze data indicative of environmental conditions external to the aircraft.

8. The monitoring system of claim 1, wherein the monitoring system comprises at least one element configured to determine the accuracy of an output of the second logic.

9. The monitoring system of claim 1, wherein the monitoring system further comprises at least one element configured to determine an escape path for the aircraft based on one of: an output of the first logic or an output of the second logic.

10. The monitoring system of claim 1, wherein in a case where the received data indicates that the object sensed by the plurality of sensors is within a predetermined distance from the aircraft, the system comprising the first logic and the second logic is configured to implement the first logic so as to override an implementation of the second logic.

11. A monitoring system for an aircraft, comprising:
a plurality of sensors for sensing an object external to the aircraft; and
a system comprising a first layer including first instructions, at least one hardware element for use in the implementation of the first instructions, a second layer including second instructions, and at least one hardware element for use in the implementation of the second instructions,
wherein the first instructions and the second instructions respectively comprise instructions for (a) receiving data indicative of an object sensed by the plurality of sensors, and (b) generating, based on the received data, an output relating to a recommendation for avoiding the sensed object,
wherein the first instructions, the at least one hardware element for use in the implementation of the first instructions, and the plurality of sensors are in conformance with a first safety standard, and
wherein the second instructions and the at least one hardware element for use in the implementation of the second instructions are in conformance with a second safety standard that is different from the first safety standard.

12. The monitoring system of claim 11, wherein the first safety standard is stricter than the second safety standard.

13. The monitoring system of claim 11, wherein the at least one hardware element for use in the implementation of the first instructions comprises a first processor configured to execute the first instructions, and
wherein the at least one hardware element for use in the implementation of the second instructions comprises a second processor configured to execute the second instructions.

14. The monitoring system of claim 13, wherein the first processor and the second processor are configured to execute the first instructions and the second instructions in parallel.

15. The monitoring system of claim 11, wherein the aircraft is self-piloted.

16. The monitoring system of claim 11, further comprising:
a third layer including third instructions for analyzing data indicative of conditions external to the aircraft.
